(19) United States
(12) Patent Application Publication
(10) Pub. No.: US 2026/0342033 A1
(43) Pub. Date: Oct. 29, 2026

(54) SYSTEM AND METHOD FOR AUTOMATIC GAIN CONTROL OF WIDEBAND HYBRID OPTICAL AMPLIFIERS

(71) Applicant: HUAWEI TECHNOLOGIES CO., LTD., SHENZHEN (CN)

(72) Inventors: Lixian WANG, Kanata (CA); Sara Shafiei ALAVIJEH, Kanata (CA); Aria MOAVEN, Kanata (CA); Zhiping JIANG, Kanata (CA)

(73) Assignee: HUAWEI TECHNOLOGIES CO., LTD., SHENZHEN (CN)

(21) Appl. No.: 19/191,859

(22) Filed: Apr. 28, 2025

(51) Int. Cl. H01S 3/067; H01S 3/094; H01S 3/10

(52) U.S. Cl. CPC H01S 3/06716; H01S 3/094003; H01S 3/10015; H01S 2301/02; H01S 2301/04

(57) ABSTRACT

There is provided an optical amplifier system including a first amplifying section to amplify optical signals in a first wavelength band and a second amplifying section to amplify optical signals in a second wavelength band different from the first wavelength band. The system includes an amplified spontaneous emission (ASE) feedback loop configured to monitor an out-band ASE signal and to maintain a predefined gain compression level of the second amplifying section and a general gain control loop configured to monitor input and output optical signal powers of the system and to maintain an average signal gain at a predefined value, the ASE feedback loop being nested within the general gain control loop to form a nested gain control architecture.

### FIELD

The present disclosure pertains to the field of optical communications, and more specifically to automatic gain control architectures and methods for integrated wideband hybrid optical amplifiers.

### BACKGROUND

The exponential growth of global data traffic continues to drive the demand for increased transmission capacity and more flexible spectrum utilization in optical communication networks. To meet these requirements, modern wavelength division multiplexing (WDM) networks have evolved into agile and reconfigurable systems capable of extending transmission capacity beyond the traditional C-band (1530-1565 nm) by leveraging existing optical fiber infrastructure.

Optical amplifiers (OA) serve as critical components in such networks, enabling signal amplification without the need for optical-to-electrical conversion. Significant advances have been made in OA technologies to support wideband amplification. State-of-the-art erbium-doped fiber amplifiers (EDFA) now support extended spectral regions such as the super C-band (1524-1572 nm) and super L-band (1574-1627 nm), each offering approximately 6 THz of bandwidth. Other OA technologies include thulium-doped fiber amplifiers (TDFA), which operate in the S-band (1460-1530 nm), bismuth-doped fiber amplifiers (BDFA), which can span the O—, E-, S-, and U-bands, and Raman fiber amplifiers (RFA), which offer tunability across various bands based on pump wavelength selection.

Despite these advances, existing OA solutions are generally limited to amplifying signals within a single wavelength band. To support broader spectral coverage, current systems require the deployment of multiple OAs, each tailored to a specific band. These systems also incorporate optical filters to split and recombine the signal into respective wavelength sub-bands before and after amplification. This design introduces several limitations, including added insertion loss from optical filters (typically ~0.5 dB), increased system complexity, and underutilized spectral regions, for instance, the gap between 1572 and 1574 nm that lies between the super C and super L bands.

To realize this integrated multi-band OA, it is necessary to incorporate two or more types of active gain media (e.g., erbium ions, bismuth centers, Raman-active fibers) within a single device. The resultant gain profile of the amplifier becomes a linear combination of the gain characteristics of the individual media. Ideally, this composite gain profile should remain fixed, independent of signal loading conditions. However, in practice, variations in the input signal such as partial channel loading, can alter the relative gain compression behaviors of the constituent gain media, leading to distortions in the overall gain profile. This effect may degrade system performance or even cause failure in the transmission of surviving channels.

To maintain gain stability under varying loading conditions, it is imperative to independently monitor and control the gain compression levels of each gain element. Conventional automatic gain control (AGC) methods, which typically rely on input and output power detection via photodetectors (PD), are insufficient in this context. These traditional systems cannot differentiate or stabilize the gain contributions from multiple active media, making them unsuitable for wideband hybrid OAs.

Accordingly, a more advanced AGC architecture is required, in particular, one that is capable of simultaneously controlling both the individual gain compression levels of the constituent media and the overall amplifier gain. Therefore, there is a need for systems and methods to implement automatic gain control for optical amplifiers that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of the present disclosure is to provide systems and methods for automatic gain control of wideband hybrid optical amplifiers.

An aspect of the disclosure provides an optical amplifier system. The system includes a first amplifying section including a first gain medium connected to a first pump source, the first amplifying section configured to amplify optical signals in a first wavelength band and a second amplifying section including a second gain medium connected to a second pump source, the second amplifying section configured to amplify optical signals in a second wavelength band different from the first wavelength band. The system further includes an amplified spontaneous emission (ASE) feedback loop configured to monitor an out-band ASE signal extracted from the output of the second amplifying section and to adjust the second pump source based on the extracted ASE signal for maintaining a predefined gain compression level of the second amplifying section. The system further includes a general gain control loop configured to monitor input and output optical signal powers of the system to calculate an actual gain of the system, and to adjust the first pump source based on the actual gain to maintain an average signal gain at a predefined value, the ASE feedback loop being nested within the general gain control loop to form a nested gain control architecture.

In some embodiments, the first gain medium and the second gain medium are doped into a same optical fiber. In some embodiments, the first amplifying section and the second amplifying section are implemented as physically separate optical fiber segments.

In some embodiments, the system further includes a plurality of the first amplifying sections and a plurality of the second amplifying sections connected in a cascaded configuration, with each of the second amplifying sections forming an ASE feedback loop.

In some embodiments, the first gain medium amplifies primarily the first wavelength band and partly the second wavelength band, and the second gain medium amplifies primarily the second wavelength band and partly the first wavelength band.

In some embodiments, the ASE feedback loop comprises a narrow optical bandpass filter positioned for extracting an out-band ASE signal from the second amplifying section, a photodetector for detecting the ASE signal, and an ASE control circuit configured to adjust the second pump source based on the detected ASE signal, the general gain control loop comprises a general gain control circuit configured to adjust the first pump source based on the detected input and output optical signal powers of the system.

In some embodiments, the first gain medium comprises erbium-doped fiber amplifier (EDFA) configured to amplify optical signals in the C-band, and the second gain medium comprises bismuth-doped fiber amplifier (BDFA) configured to amplify optical signals in the L-band.

In some embodiments, the first gain medium comprises erbium-doped fiber amplifier (EDFA) configured to amplify optical signals in the C-band, and the second gain medium comprises bismuth-erbium co-doped fiber amplifier (BEDFA) configured to amplify optical signals in the L-band.

In some embodiments, the first gain medium comprises bismuth-doped fiber amplifier (BDFA) configured to amplify optical signals in the E-band and the shorter wavelength portion of the S-band, and the second gain medium comprises erbium-doped fiber amplifier (EDFA) configured to amplify signals in the longer wavelength portion of the S-band.

Another aspect of the disclosure provides an optical amplifier system. The system includes a first amplifying section including a first gain medium connected to a pump source, the first amplifying section configured to amplify optical signals in a first wavelength band and a second amplifying section including a second gain medium configured to amplify optical signals in a second wavelength band different from the first wavelength band. The system further includes an optical gain clamping (OGC) loop including a variable optical attenuator (VOA) optically coupled to the input and output of the second amplifying section, the OGC loop configured to extract an out-band amplified spontaneous emission (ASE) signal from the output and recirculate an attenuated ASE signal to the input of the second amplifying section to maintain a predefined gain compression level of the second amplifying section. The system further includes a general gain control loop configured to monitor input and output optical signal powers of the system to calculate an actual gain of the system, and to adjust the pump source based on the actual gain to maintain an average signal gain at a predefined value, the OGC loop being nested within the general gain control loop to form a nested gain control architecture.

In some embodiments the first gain medium and the second gain medium are doped into a same optical fiber. In some embodiments the first amplifying section and the second amplifying section are implemented as physically separate optical fiber segments.

In some embodiments the first gain medium amplifies primarily the first wavelength band and partly the second wavelength band, and the second gain medium amplifies primarily the second wavelength band and partly the first wavelength band.

In some embodiments, the system further includes a plurality of the first amplifying sections and a plurality of the second amplifying sections connected in a cascaded configuration, with each of the second amplifying sections forming an OGC loop.

In some embodiments the first gain medium comprises erbium-doped fiber amplifier (EDFA) configured to amplify optical signals in the C-band, and the second gain medium comprises bismuth-doped fiber amplifier (BDFA) configured to amplify optical signals in the L-band.

In some embodiments, the first gain medium comprises erbium-doped fiber amplifier (EDFA) configured to amplify optical signals in the C-band, and the second gain medium comprises bismuth-erbium co-doped fiber amplifier (BEDFA) configured to amplify optical signals in the L-band.

In some embodiments the first gain medium comprises bismuth-doped fiber amplifier (BDFA) configured to amplify optical signals in the E-band and the shorter wavelength portion of the S-band, and the second gain medium comprises erbium-doped fiber amplifier (EDFA) configured to amplify signals in the longer wavelength portion of the S-band.

Another aspect of the disclosure provides a method for controlling gain in a hybrid optical amplifier system. The method includes amplifying a first portion of an optical signal spectrum using a first gain medium in a first amplifying section of the system and amplifying a second portion of the optical signal spectrum using a second gain medium in a second amplifying section of the system, the first amplifying section and the second amplifying section connected in a cascaded configuration. The method further includes maintaining a gain compression level of the second gain medium by monitoring an out-band amplified spontaneous emission (ASE) signal associated with the second gain medium and adjusting an optical control parameter based on the monitored ASE signal. The method additionally includes measuring input and output optical signals of the optical amplifier system and calculating an actual signal gain based on the measured input and output signals. The method further includes adjusting a first pump power sent to the first gain medium based on the calculated actual signal gain to maintain a predefined average signal gain of the optical amplifier system.

In some embodiments the optical control parameter comprises a second pump power sent to the second gain medium, and the monitoring of the out-band ASE signal comprises detecting the ASE signal using a photodetector positioned after a narrow optical bandpass filter provided at an output of the second gain medium.

In some embodiments the optical control parameter comprises an attenuation level of a variable optical attenuator (VOA) configured to recirculate an attenuated ASE signal to the second gain medium through an optical gain clamping (OGC) loop coupled to the input and output of the second gain medium.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1A illustrates an overall gain profile based on contributions from two types of active elements.

FIG. 1B illustrates another overall gain profile based on contributions from two types of active elements.

FIG. 2 illustrates an automatic gain control (AGC) system.

FIG. 3 illustrates optical gain clamping (OGC) that uses an internal laser loop to stabilize gain in thulium-doped fiber amplifiers (TDFAs).

FIG. 4 illustrates optical and electrical feedback for gain stabilization across wider bandwidths.

FIG. 5 illustrates a dynamic gain equalizer (DGE) to compensate gain variation in systems combining Raman and erbium amplifiers.

FIG. 6 illustrates a general schematic of a nested AGC architecture, according to embodiments.

FIG. 7 illustrates a schematic of a nested AGC architecture, according to embodiments.

FIG. 8A illustrates gain deviation vs wavelength of a bismuth-doped fiber (BDF)-erbium-doped fiber (EDF) hybrid amplifier, according to embodiments.

FIG. 8B illustrates number of occurrence vs maximum gain deviation of a BDF-EDF hybrid optical amplifier, according to embodiments.

FIG. 9 illustrates an erbium-doped fiber (EDF)-bismuth-doped fiber (BDF) hybrid optical amplifier, according to embodiments.

FIG. 10 illustrates a bismuth-doped fiber (BDF)-erbium-doped fiber (EDF) hybrid optical amplifier, according to embodiments.

FIG. 11 illustrates another erbium-doped fiber (EDF)-bismuth-doped fiber (BDF) hybrid optical amplifier, according to embodiments.

FIG. 12 illustrates another bismuth-doped fiber (BDF)-erbium-doped fiber (EDF) hybrid optical amplifier, according to embodiments.

FIG. 13 illustrates yet another an erbium-doped fiber (EDF)-bismuth-doped fiber (BDF) hybrid optical amplifier, according to embodiments.

FIG. 14 illustrates yet another bismuth-doped fiber (BDF)-erbium-doped fiber (EDF) hybrid optical amplifier, according to embodiments.

FIG. 15 illustrates an erbium-doped fiber (EDF)-bismuth-erbium-co-doped fiber (BEDF) hybrid optical amplifier, according to embodiments.

FIG. 16 illustrates a bismuth-erbium-co-doped fiber (BEDF)-erbium-doped fiber (EDF) hybrid optical amplifier, according to embodiments.

FIG. 17 illustrates another erbium-doped fiber (EDF)-bismuth-erbium-co-doped fiber (BEDF) hybrid optical amplifier, according to embodiments.

FIG. 18 illustrates a bismuth-erbium-co-doped fiber (BEDF)-erbium-doped fiber (EDF) hybrid optical amplifier hybrid optical amplifier, according to embodiments.

FIG. 19 illustrates a method for controlling gain in a hybrid optical amplifier system configured with multiple amplifying sections connected in a cascaded configuration, according to embodiments.

It will be noted that throughout the appended drawings, like features are identified by like reference numerals.

### DETAILED DESCRIPTION

Conventional wavelength division multiplexing systems primarily utilize the C-band (1530-1565 nm), but to further increase capacity, modern systems have started extending into the S-, L-, and even E-bands. This has led to the deployment of wideband optical amplifiers capable of amplifying signals beyond the traditional C-band.

Various types of optical amplifiers have been developed to address different wavelength bands. For instance, erbium-doped fiber amplifiers (EDFA) are optimized for the C- and L-bands, thulium-doped fiber amplifiers (TDFA) are suitable for the S- and U-bands, and bismuth-doped fiber amplifiers (BDFA) can amplify across the O—, E-, and S-bands. Raman fiber amplifiers (RFA) can be tuned across a broad range depending on the pump wavelength. While these amplifiers are effective in their respective spectral regions, most commercial OAs are limited to amplifying only a single wavelength band.

This limitation results in significant system complexity for multi-band applications. For instance, in a conventional multi-band optical amplifier system, optical filters are required to split and recombine different wavelength bands, as shown in the general schematic of such systems. These components introduce insertion losses, typically around 0.5 dB, and cause bandwidth loss at transition regions, such as the 1572-1574 nm range between the super C and super L bands. Moreover, splitting and recombination increase component count, physical footprint, and power consumption.

To overcome these challenges, integrated wideband hybrid optical amplifiers capable of amplifying multiple wavelength bands simultaneously using a combination of gain media have been proposed. Such systems use multiple active/gain elements (e.g., erbium ions, bismuth centers, or co-doped fiber compositions) to cover the desired spectrum.

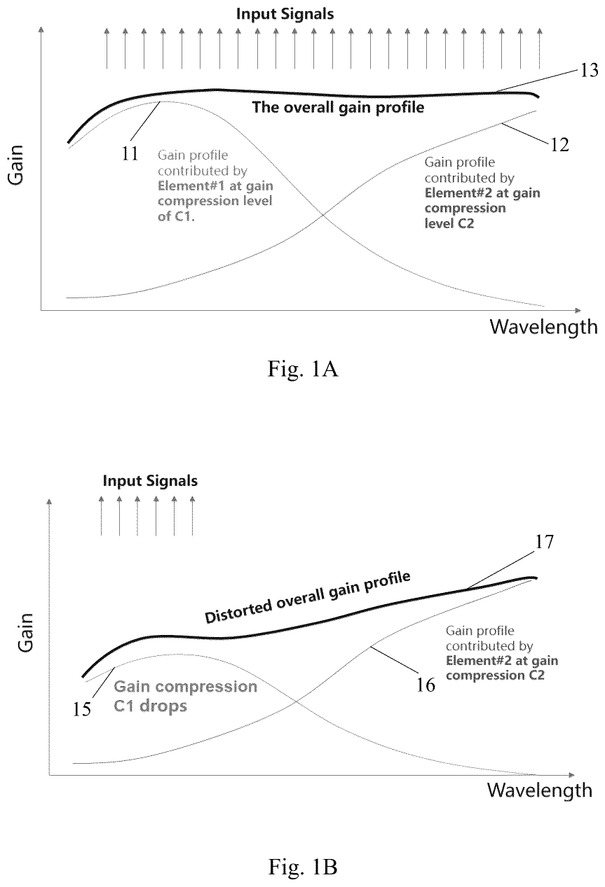

One of the core technical challenges addressed by the present disclosure is the instability of the gain profile in hybrid optical amplifiers under varying signal loading conditions. As shown in FIG. 1A, when all WDM channels are fully loaded, the combined gain contributions from two different active/gain elements 11, 12, each covering a distinct wavelength band, produce a flat and continuous gain profile 13 across the amplifier's bandwidth. However, in real-world optical networks, the traffic pattern often changes dynamically, leading to partial channel loading. In such cases, as illustrated in FIG. 1B, the relative gain compression levels of the gain elements 15, 16 become imbalanced. One gain medium may enter compression while the other remains in a linear regime, resulting in an uneven gain profile 17 across the spectrum. This mismatch leads to gain profile distortion, characterized by spectral dips or tilts, which can degrade signal quality, impair equalization, and increase bit error rates in transmission systems. These effects are especially problematic in wideband hybrid OAs, where consistent spectral gain is critical for seamless multi-band signal amplification. The present disclosure directly addresses this issue by enabling independent control of the gain compression state of one gain element, thereby maintaining spectral flatness even under variable loading conditions.

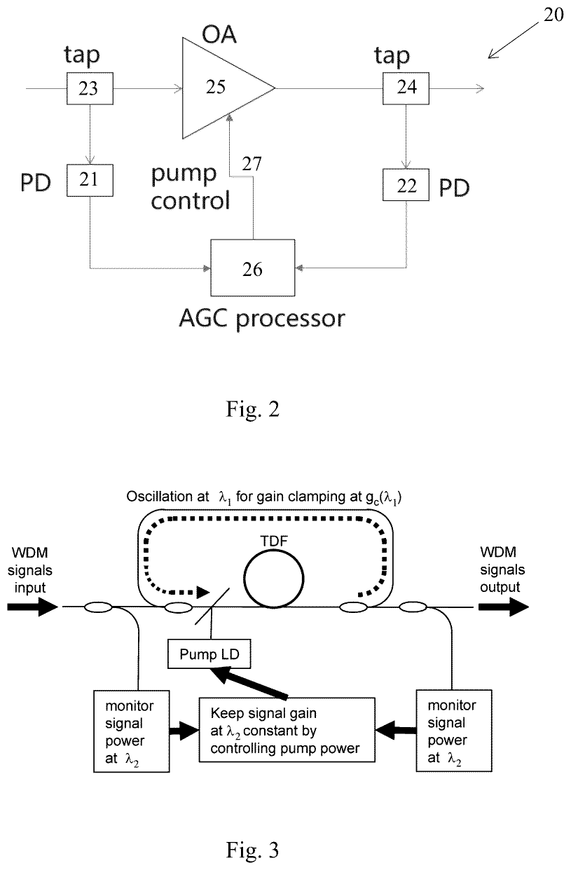

Traditional automatic gain control (AGC) systems, such as the system 20 shown in FIG. 2, rely on photodetectors 21, 22 placed at the taps 23, 24 of input and output of the OA 25 to measure total signal power. A control processor 26 compares the measured gain against a predefined target and adjusts the pump power 27 accordingly. While this approach is effective for single-band OAs with a single gain medium, it does not account for the individual or relative gain compression behaviors of multiple gain elements within a hybrid OA.

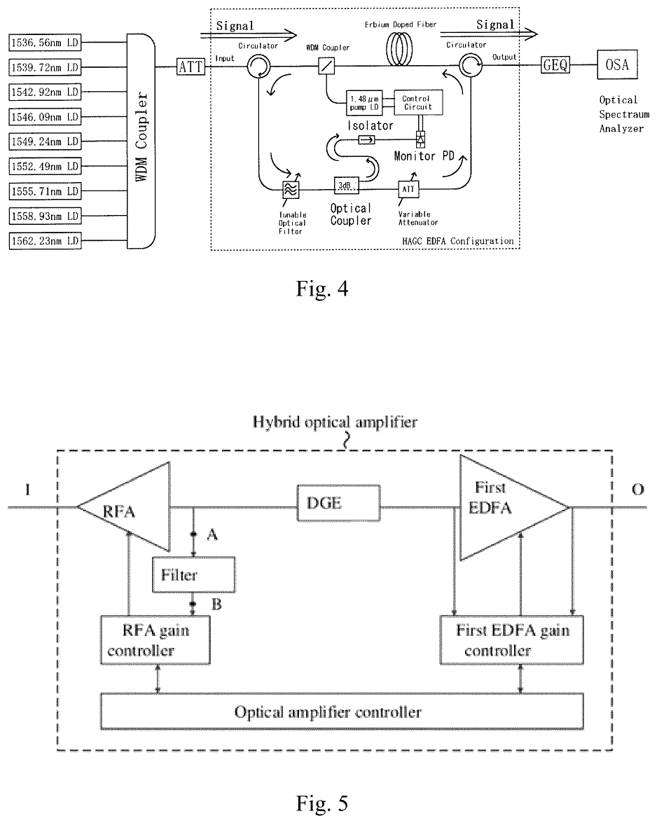

Several prior art approaches have attempted to enhance AGC techniques. Optical Gain Clamping (OGC) technique, illustrated in FIG. 3, uses an internal laser loop 31 to stabilize gain in TDFAs. FIG. 4 illustrates an example that combines electronic and optical gain control technique to stabilize the gain of an EDFA across a wider bandwidth. However, this configuration introduces additional system complexity, which may result in increased latency and electrical noise due to the conversion of optical signals into electrical signals and subsequent signal processing.

FIG. 5 illustrates another example that employs two independent gain control loops: one for controlling the Raman fiber amplifiers (RFAs) and the other for controlling the EDFA. A dynamic gain equalizer (DGE) is included to compensate for variations in the gain profiles or gain compression levels of both amplifier stages. The DGE functions as a programmable gain flattening module positioned downstream of the amplifier chain. While this approach enhances spectral uniformity, it adds cost and complexity and performs post-compensation rather than directly regulating the internal gain dynamics of each amplifying section. Overall, these techniques are either limited to single gain medium systems or rely on external post-compensation using costly and complex devices like DGEs. Furthermore, these solutions do not effectively alleviate the relative gain compression levels of multiple amplifying sections in an integrated hybrid OA.

According to an embodiment, there is provided a nested automatic gain control (AGC) architecture and method for implemented in wideband hybrid optical amplifiers. The embodiment of the present technology can enable independent locking of the gain compression levels of two or more active or gain elements while simultaneously locking the overall averaged signal gain of the system to a predefined target. This dual control mechanism can significantly reduce the deviation of the composite gain profile under varying signal loading conditions, thereby improving spectral flatness and system performance.

In a wideband hybrid OA, the total gain spectrum is formed by combining multiple amplifying elements, each covering a specific wavelength sub-band. For instance, as illustrated in FIG. 7, in an E+S band configuration, a bismuth-doped fiber (BDF) provides gain across the E-band and shorter wavelengths of the S-band (approximately 1450-1490 nm), while an erbium-doped fiber (EDF) handles longer wavelengths of the S-band (approximately 1490-1520 nm).

In certain embodiments, the first and second gain mediums may be configured in different structural arrangements to achieve flexible integration and optimized performance across target wavelength bands. For example, the first gain medium and the second gain medium are co-doped into a single optical fiber, forming a co-doped amplifying section. Such a configuration may utilize a fiber simultaneously doped with erbium and bismuth ions (e.g., bismuth/erbium co-doped fiber), thereby supporting both C-band and L-band or E-band and S-band amplification within a single physical medium. This approach can facilitate compact integration and may reduce splice losses and component count in systems requiring space or cost efficiency.

Alternatively, the first and second amplifying sections can be implemented as physically separate optical fiber segments, each incorporating its respective dopant and tailored gain profile. For instance, an erbium-doped fiber (EDF) may be spliced in sequence with a bismuth-doped fiber (BDF) or bismuth-erbium co-doped fiber (BEDF).

Furthermore, in some embodiments, the spectral amplification bands of the two gain mediums may partially overlap. In such configurations, the first gain medium may provide gain predominantly in a first wavelength band while also contributing to the amplification of part of the second wavelength band. Conversely, the second gain medium may primarily cover the second wavelength band but extend its gain into part of the first wavelength band. This partial spectral overlap can ensure smooth transitions and more uniform gain profiles across the amplifier's entire operational bandwidth.

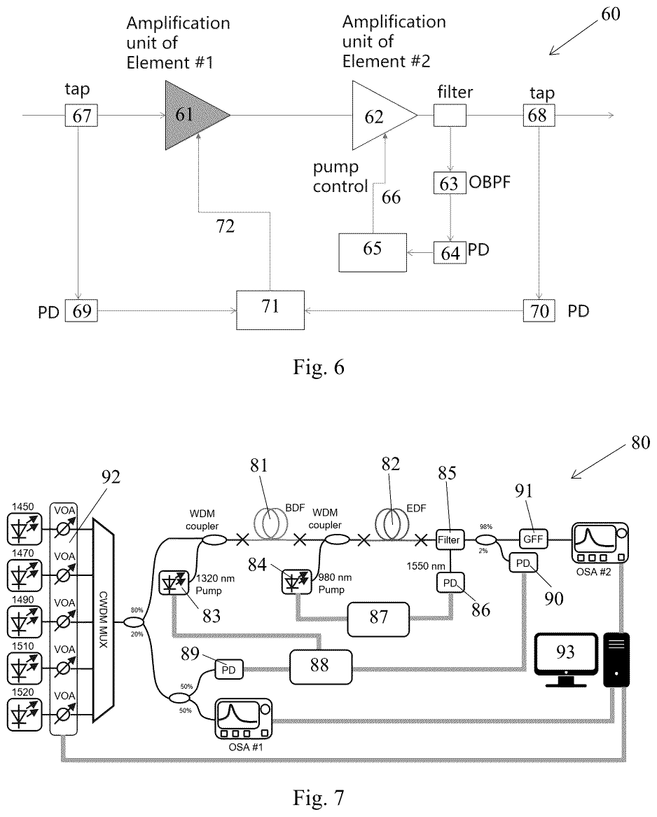

A general schematic of the mentioned nested AGC architecture implemented in a wideband optical amplifier system 60 is shown in FIG. 6. The amplifier's main optical path includes two amplifying sections 61, 62 of two different types of gain media, i.e., a first gain medium and a second gain medium, connected in a cascaded arrangement. A narrow optical bandpass filter (OBPF) 63 is inserted within the optical path to extract an out-band amplified spontaneous emission (ASE) signal which is emitted specifically by the second gain medium. The filter 63 has a narrow spectral bandwidth and is tuned to isolate ASE that lies outside the signal band, which can ensure the monitored ASE signal is only dependent on the gain compression level of the second amplifier. The filtered ASE signal is directed to a photodetector 64, and its measured power is processed by a control circuit 65, which is configured to adjust the power of an optical pump 66 and recirculate back to the second gain medium to form an ASE feedback control loop, thereby maintaining the gain compression level of the second amplifying section to a predefined target value.

In parallel, a general AGC loop governs the total signal gain. Input and output taps 67, 68 are positioned at the system boundaries, and photodetectors 69, 70 collect the respective signal power levels. These readings are supplied to control circuit 71, which calculates the actual system gain and adjusts the power of a second optical pump 72 sent to the first amplifying section 61 to maintain a stable overall average gain. By nesting the ASE feedback control loop inside the AGC loop, the system 60 can independently stabilizes both the local gain compression and the overall amplifier gain.

An experimental demonstration of an embodiment is shown in FIG. 7. The implemented OA is an E+S band hybrid amplifier 80 using bismuth-doped fiber amplifier (BDFA) 81 and erbium-doped fiber amplifier (EDFA) 82, cascaded such that the BDFA 81 is upstream of the EDFA 82. The BDFA 81 is pumped with 1320 nm light by optical pump 83, and the EDFA with 980 nm by optical pump 84. A narrowband optical filter 85 centered at 1550 nm with approximately 1 nm bandwidth is placed at the output of the EDFA 82 to extract ASE signal. The power of the 1550 nm ASE signal is monitored by photodetector 86 and fed to control circuit 87, which adjusts the power of pump 84 to lock the ASE signal power. Meanwhile, control circuit 88 adjusts optical pump 83 based on input/output signal power measurements obtained by photodetectors 89, 90 to maintain the overall gain. A gain flattening filter (GFF) 91 may be placed at the system's output to shape the gain profile across the 1450-1520 nm band under full-loading conditions, where all input WDM laser lines are active and set to equal power levels by variable optical attenuators (VOA) 92. A computer 93 (e.g. PC) may be used to collect optical spectra and adjust the VOAs in the testbed to simulate different input loading profiles.

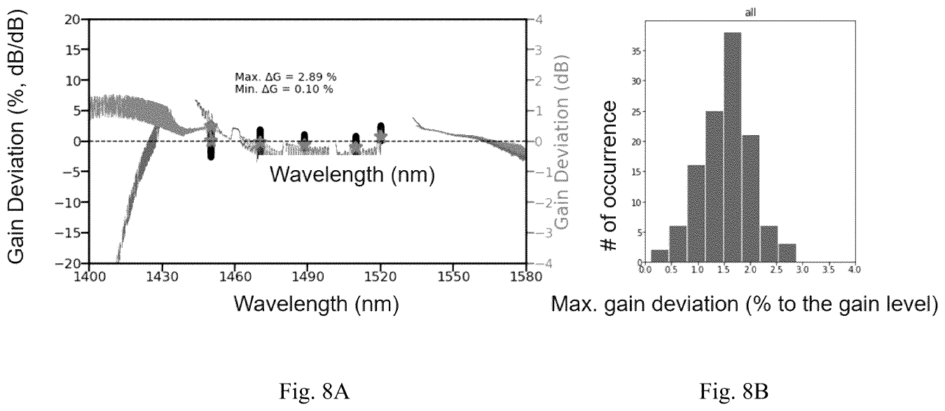

As shown in FIG. 8A, when all input channels are active (full-loading), the system can achieve a substantially flat gain profile. Under partial loading, i.e., when input channel powers are set randomly, gain distortion arises. The black dots in FIG. 8A plot the gain deviation relative to the full-loading baseline. The worst-case gain deviation, measured both in percentage (dB/dB) and absolute dB, is highlighted. The blue curve shows the partial-loading gain deviation profile; the orange curve shows the full-loading profile. FIG. 8B presents a histogram of gain deviation in percentage (dB/dB), confirming that the nested AGC architecture reduces worst-case gain deviation to as low as 2.89%. This result validates that the nested AGC architecture according to embodiments can effectively suppress gain profile distortion caused by uneven channel loading and provides consistent spectral performance in wideband hybrid optical amplifiers.

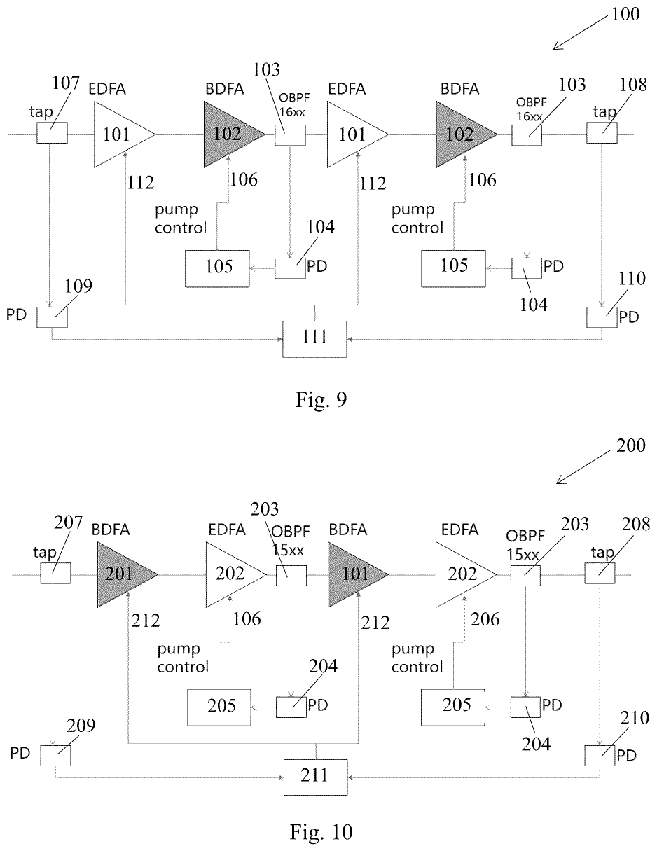

Referring to FIG. 9, an embodiment incorporating multiple amplifying sections is shown. Specifically, this embodiment directs to a hybrid optical amplifier system 100 for simultaneous amplification over the C+L bands. The system 100 includes multiple first amplifying sections 101 and second amplifying sections 102 connected in a cascaded configuration, as shown. Each of the first amplifying sections 101 includes a first gain medium, for instance, an erbium-doped fiber amplifier (EDFA) configured to amplify signals in the C band, while each of the second amplifying sections 102 includes a second gain medium, bismuth-doped fiber amplifier (BDFA), configured to amplify signals in the L band. For instance, the second amplifying sections 102 may be implemented using bismuth-doped silica fiber highly doped with germanium. The first amplifying sections, i.e., EDFA sections 101, and the second amplifying sections, i.e., BDFA sections 02, are configured as pairs, with the EDFA section 101 positioned upstream of the BDFA section 102 within each pair, along the optical signal path.

The optical amplifier system 100 features a nested automatic gain control architecture for stabilizing both the internal gain compression levels of the BDFA sections 102 and the overall average signal gain of the system. Specifically, at each of the BDFA sections 102, a narrowband optical bandpass filter 103 centered at approximately 16xx nm is positioned at the output port of each BDFAs. The narrowband optical bandpass filter 103 extracts an out-band amplified spontaneous emission (ASE) signal that lies outside the amplified signal band. The extracted ASE light is then detected by a photodetector 104, and the resulting electrical signal is supplied to a control circuit 105. The control circuit 105 adjusts the pump power 106 sent to the BDFA section 102 to lock the ASE power, thereby the gain compression level, to a predefined value. As a result, this configuration forms an ASE feedback control loop (i.e., inner loop) that effectively locks the gain compression level of the BDFA to a target value, independent of variations in signal loading. The ASE feedback control loop is configured to monitor and regulate the compression state of each of the BDFA sections 102.

As shown, a pair of optical taps 107, 108 is positioned at the input and output ports of the system 100, each coupled to a respective photodetector 109. 110. The photodetectors 109, 110 measure the input and output signal powers, which are provided to another control circuit 111 that monitors and stabilizes the overall signal gain of the amplifier system. This configuration forms a general AGC loop (i.e., outer loop). The control circuit 111 calculates the actual signal gain and adjusts the pump powers 112 supplied to the EDFA sections 101, thereby maintaining the overall average gain of the amplifier system 100 at a predefined target.

FIG. 10 illustrates a hybrid optical amplifier system 200, presented as an alternative configuration to that shown in FIG. 9. This configuration is adapted for E+S band amplification while retaining the same overall structural architecture. In this configuration, the first amplifying sections 201, i.e., BDFA sections, and the second amplifying sections 202, i.e., EDFA sections, are configured as pairs, with the BDFA section 201 positioned upstream of the EDFA section 202 within each pair, along the optical signal path. The BDFA sections may use BDF based on silica glass doped by low level of germanium. The BDFA provides gain in the E band and the lower portion of the S band, while the EDFA amplifies the upper portion of the S band. Narrowband optical bandpass filter 203 centered at approximately 15xx nm is used to extract out-band ASE from each EDFA sections 202 and detected by a photodetector 204, and the resulting electrical signal is supplied to a control circuit 205. The control circuit 205 adjusts the pump power 206 sent to the EDFA section 202 to lock the gain compression level to a predefined value through an ASE feedback loop.

Similar to system 100, a pair of optical taps 207, 208 is positioned at the input and output ports of the system 200, each coupled to a respective photodetector 209, 210. The photodetectors 209, 210 measure the input and output signal powers, which are provided to another control circuit 211 that monitors and stabilizes the overall signal gain through a general AGC loop. The control circuit 211 calculates the actual signal gain and adjusts the pump powers 212 supplied to the BDFA sections 201, thereby maintaining the overall average gain of the amplifier system 200 at a predefined target. The nested AGC architecture, wherein the ASE feedback control loops are nested within the general AGC loop, can effectively minimize gain profile distortion caused by unbalanced signal loading or traffic variations across the amplifier bandwidth, making the system well-suited for high-performance optical networks operating over the C+L or E+S bands.

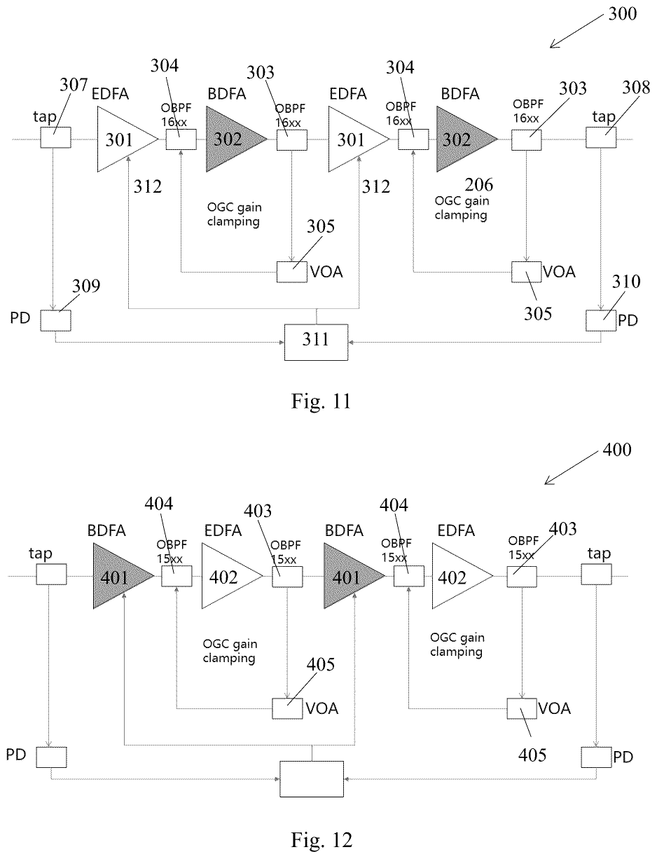

FIG. 11 illustrates another embodiment directed towards a hybrid optical amplifier system 300 configured for simultaneous amplification over the C+L bands. The system 300 incorporates multiple amplifying sections including EDFA 302 sections and BDFA sections 302 connected in a cascaded configuration according to the exact same manner as that of system 100 shown in FIG. 9.

In contrast to the use of ASE-based feedback control in the previous embodiments, the present embodiment employs optical gain clamping technique for stabilizing the gain compression level of the BDFA sections 302. Specifically, narrowband optical bandpass filter 303 centered at approximately 16xx nm are placed at output port of each BDFA section 302. The filter 303 extracts an out-band ASE signal from the BDFA, which is then routed into a variable optical attenuator (VOA) 305. The attenuated ASE signal is then coupled back into the BDFA input through another optical bandpass filter 304, forming a closed OGC loop for each BDFA section 302. The attenuation level of the VOA 305 is adjustable and used to fine-tune the loop loss. By adjusting the VOA 305, the clamped gain compression level of the BDFA can be locked to a predefined value, thereby stabilizing the gain behavior of each BDFA section 302.

As in the previous embodiments, the system 300 includes a general AGC loop configured to monitor and stabilize the overall average signal gain of the optical amplifier. A pair of optical taps 207, 208 is positioned at the input and output ports of the system 200, each coupled to a respective photodetector 209, 210. The photodetectors 209, 210 measure the input and output signal powers, which are provided to a control circuit 311 that monitors and stabilizes the overall signal gain through the general AGC loop. The control circuit 311 calculates the actual signal gain and adjusts the pump powers 312 supplied to the EDFA sections 301, thereby maintaining the overall average gain of the amplifier system 300 at a predefined target.

FIG. 12 illustrates a hybrid optical amplifier system 400, presented as an alternative configuration to that of system 300 shown in FIG. 11. This configuration is adapted for E+S band amplification while retaining the same overall structural architecture. In this configuration, the first amplifying sections 401, i.e., BDFA sections, and the second amplifying sections 402, i.e., EDFA sections, are configured as pairs, with the BDFA section 401 positioned upstream of the EDFA section 402 within each pair, along the optical signal path. The BDFA sections may use BDF based on silica glass doped by low level of germanium. The BDFA provides gain in the E band and the lower portion of the S band, while the EDFA amplifies the upper portion of the S band. Narrowband optical bandpass filters 403, 404 centered at approximately 15xx nm is used to extract and recirculate out-band ASE in each EDFA sections 402 by a VOA 405 for gain compression control through an OGC loop. As shown, the system 400 further includes a general AGC loop configured identically to that of system 300 for maintaining the overall average gain of the amplifier system 400 at a predefined target.

The system 300 and system 400 illustrate a nested control architecture in which the OGC loop operating locally is nested within a general AGC loop that regulates the overall system gain. In contrast to the system 100 and system 200 illustrated in FIG. 9 and FIG. 10, where gain compression control is achieved through electronic ASE feedback-based technique, the OGC loop in this embodiment can be implemented with only optical components allows for full optical regulation of the internal gain compression behavior of the second amplifying sections.

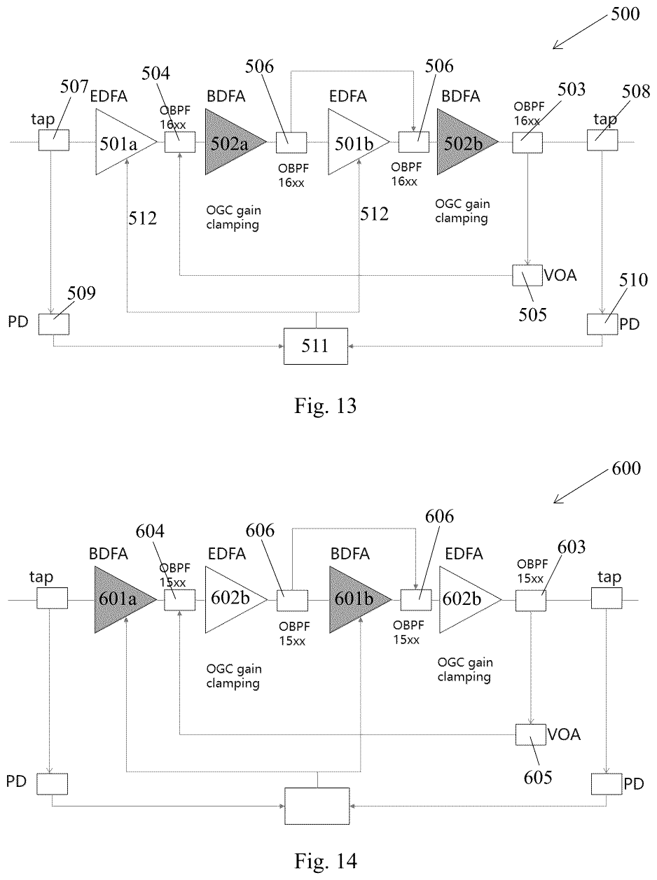

FIG. 13 illustrates yet another embodiment directed to an optical amplifier system 500 configured for simultaneous amplification over the C+L bands. This embodiment features a hybrid optical amplifier structure including multiple EDFA sections 501 and BDFA sections 502, arranged in a cascaded configuration, in the exact same manner as shown in FIG. 11.

Specifically, the system 500 utilizes a single OGC loop configured to collectively control the gain compression behavior across multiple BDFA sections 502a, 502b. To enable this, narrowband optical bandpass filters, centered around 16xx nm, are placed at the input and output ports of each BDFA section. The filter 503 at the output port of the downstream BDFA section 502b is used to extract the out-band ASE signal, while the filter 504 at the input port of the upstream BDFA section 502a serves as the re-entry point for the ASE signal into the optical path. The extracted ASE signal is directed through a VOA 505 before being coupled back into the upstream BDFA section 502a via the upstream filter 504, forming the OGC loop.

To ensure the 16xx nm ASE signal remains confined within the BDFA chain, optical bandpass filters 506 are configured to bridge the EDFA section 501b in-between the two BDFA sections 502a, 502b so that the 16xx nm out-band ASE signal will not pass through the downstream EDFA section 501b. This arrangement creates an OGC loop that circulates the out-band ASE exclusively within the two BDFA sections 502a, 502b. By adjusting the attenuation level of the VOA 505, the gain compression within the OGC loop can be precisely controlled, thereby locking the aggregate gain compression level of the BDFA sections to a predefined value.

A pair of optical taps 507, 508 is positioned at the input and output ports of the system 500, each coupled to a respective photodetector 509, 510. The photodetectors 509, 510 measure the input and output signal powers, which are provided to a control circuit 511 that monitors and stabilizes the overall signal gain of the amplifier system 500. This configuration forms a general AGC loop. The control circuit 511 calculates the actual signal gain and adjusts the pump powers 512 supplied to the EDFA sections 501a, 501b, thereby maintaining the overall average gain of the amplifier system 500 at a predefined target.

FIG. 14 illustrates a hybrid optical amplifier system 600, presented as an alternative configuration to that of system 500 as shown in FIG. 13. This configuration is adapted for E+S band amplification while retaining the same overall structural architecture. In this configuration, the BDFA sections 601a, 601b and EDFA sections 602a, 602b are configured as pairs, with the BDFA section positioned upstream of the EDFA section within each pair. The BDFA sections may use BDF based on silica glass doped by low level of Germanium. The BDFA provides gain in the E band and the lower portion of the S band, while the EDFA amplifies the upper portion of the S band. Narrowband optical bandpass filters 603, 604 centered at approximately 15xx nm is used to extract and recirculate out-band ASE from the downstream EDFA section 602b to the upstream BDFA section 601a by a VOA 605 for gain compression control through an OGC loop. Additional narrowband optical bandpass filters 606 are used to bridge the downstream BDFA section 601b in-between the two EDFA sections 602a, 602b so that the 15xx nm out-band ASE signal will not pass through the downstream BDFA section 601b. As shown, the system 600 further includes a general AGC loop configured identically to that of system 500 for maintaining the overall average gain of the amplifier system 600 at a predefined target.

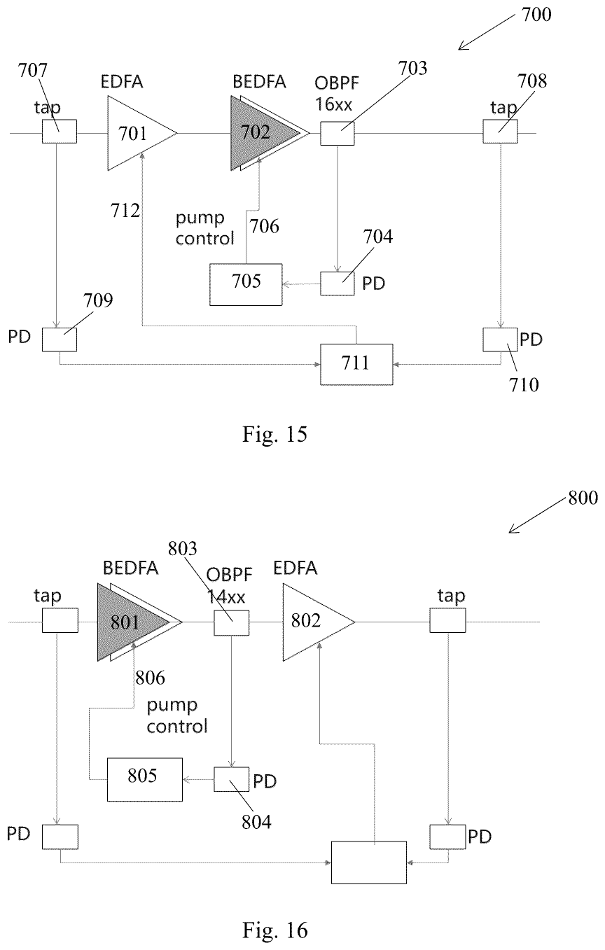

FIG. 15 illustrates another embodiment directed to a hybrid optical amplifier system 700 configured for simultaneous amplification over the C+L bands. The system 700 includes a sequence of two different amplifying sections connected in a cascaded configuration. The first amplifying section includes an EDFA for C-band amplification, while the second amplifying section includes a BEDFA configured to amplify signals in the L band. The BEDFA may be implemented using a bismuth-erbium co-doped fiber formed from silica glass highly doped with germanium. As illustrated, the EDFA section 701 is positioned upstream of the BEDFA section 702 along the optical signal path.

To regulate the internal gain compression level of the BEDFA, the output end of the BEDFA section 702 is provided with a narrowband optical bandpass filter 703 centered at approximately 16xx nm, placed at its output port. The optical bandpass filter 703 extracts an out-band ASE signal, which is directed to a photodetector 704 for power measurement. The measured ASE power serves as an indicator of the gain compression level of the BEDFA. The output of the photodetector 704 is fed into a control circuit 705 which adjusts pump power 706 supplied to the BEDFA section 702 to lock its gain compression level to a predefined value. This configuration implements an ASE feedback control loop at the BEDFA section 702 which enables independent compression control of the BEDFA regardless of changes in input signal loading.

In addition, a pair of optical taps 707, 708 is positioned at the input and output ports of the system 700, each coupled to a respective photodetector 709, 710. The photodetectors 709, 710 measure the input and output signal powers, which are provided to another control circuit 711 that monitors and stabilizes the overall signal gain of the amplifier system 700. This configuration forms a general AGC loop. The control circuit 711 calculates the actual signal gain and adjusts pump power 712 supplied to the EDFA section 701, thereby maintaining the overall average gain of the amplifier system 700 at a predefined target.

FIG. 16 illustrates a hybrid optical amplifier system 800, presented as an alternative configuration to that of system 700 as shown in FIG. 15. This configuration is adapted for E+S band amplification while retaining the same overall structural architecture. In this embodiment, the BEDFA section 801 is positioned upstream of the EDFA section 802 along the optical path. The BEDFA may include bismuth-doped fiber with low germanium doping. The BEDFA section 801 provides gain in the E band and the lower portion of the S band, while the EDFA section 802 amplifies the upper portion of the S band. The system utilizes a narrowband optical bandpass filter 803 centered at approximately 14xx nm to extract out-band ASE from the BEDFA section 801 and detected by a photodetector 804, and the resulting electrical signal is supplied to a control circuit 805. The control circuit 805 adjusts pump power 806 sent to the BEDFA section 801 to lock the gain compression level to a predefined value through an ASE feedback loop. As shown, the system 800 further includes a general AGC loop configured identically to that of system 700 for maintaining the overall average gain of the amplifier system 800 at a predefined target.

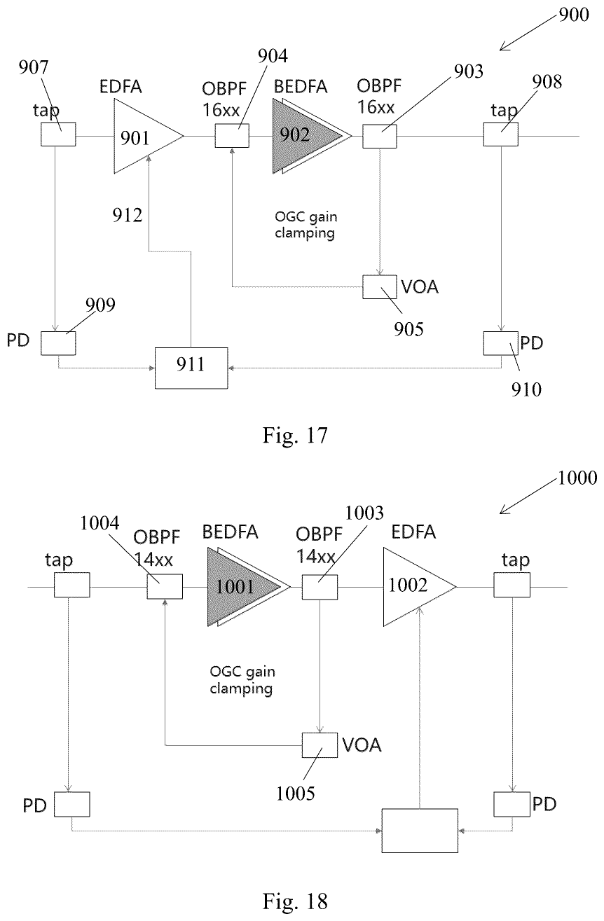

FIG. 17 illustrates an embodiment which is structurally similar to that in FIG. 15 but differs in the method used to control the gain compression of the BEDFA. The optical amplifier system 900 includes cascaded EDFA section 901 and BEDFA section 902, configured for broadband amplification across the C+L bands. As shown, the EDFA section 901 is positioned upstream of the BEDFA section 902 along the optical signal path. The BEDFA section may include bismuth-erbium-co-doped fibers that are based on silica glass doped by low level of Germanium.

In contrast to the ASE feedback control technique illustrated in FIG. 16, this embodiment utilizes OGC technique to regulate the gain compression level of the BEDFA. In this configuration, narrowband optical bandpass filters 903, 904 centered at approximately 16xx nm are positioned at both the input and output ports of the BEDFA section 902. Filter 903 at the output port extracts out-band ASE signal and is then routed into a VOA 905. After passing through the VOA, the attenuated ASE signal is recirculated into the BEDFA section 902 through filter 904 at the input port of the BEDFA. The VOA 905 is configured to control the loss within the OGC loop, and by tuning the attenuation level, the loop effectively clamps the ASE power circulating within the BEDFA section 902.

As in prior embodiments, a pair of optical taps 907, 908 is positioned at the input and output ports of the system 900, each coupled to a respective photodetector 909, 910. The photodetectors 909, 910 measure the input and output signal powers, which are provided to a control circuit 911 that monitors and stabilizes the overall signal gain of the amplifier system 900. This configuration forms a general AGC loop. The control circuit 911 calculates the actual signal gain and adjusts pump power 912 supplied to the EDFA section 901, thereby maintaining the overall average gain of the amplifier system 900 at a predefined target.

FIG. 18 illustrates a hybrid optical amplifier system 1000, presented as an alternative configuration to that of system 900 as shown in FIG. 17. This configuration is adapted for E+S band amplification while retaining the same overall structural architecture. In this embodiment, the BEDFA section 1001 is positioned upstream of the EDFA section 1002 along the optical path. The BEDFA section may use bismuth-erbium-co-doped fibers that are based on silica glass doped by low level of germanium. The BEDFA section 1001 provides gain in the E band and the lower portion of the S band, while the EDFA section 1002 amplifies the upper portion of the S band. The system utilizes a narrowband optical bandpass filter 1003 centered at approximately 14xx nm to extract out-band ASE from the BEDFA section 1001 and routed into a VOA 1005. After passing through the VOA, the attenuated ASE signal is recirculated into the BEDFA section 1001 through filter 1004 at the input port of the BEDFA. The VOA 1005 is configured to control the loss within the OGC loop, and by tuning the attenuation level, the loop effectively clamps the ASE power circulating within the BEDFA section 1001 without reliance on electrical feedback. As shown, the system 1000 further includes a general AGC loop configured identically to that of system 900 for maintaining the overall average gain of the amplifier system 1000 at a predefined target.

The foregoing embodiments collectively demonstrate the flexibility and effectiveness of the nested automatic gain control architecture applied to hybrid optical amplifiers spanning a wide range of spectral bands, including C+L bands and E+S bands. Across the various configurations, the amplifier systems integrate different types of gain media, such as erbium-doped fiber (EDF), bismuth-doped fiber (BDF), and bismuth-erbium co-doped fiber (BEDF), arranged in cascaded pairs to cover complementary wavelength ranges.

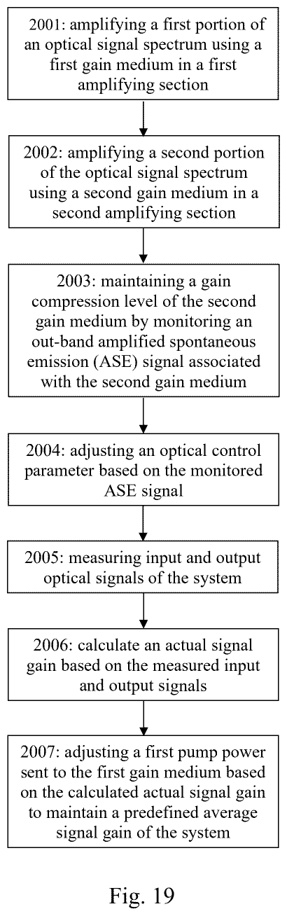

According to another aspect, there is provided a method for controlling gain in a hybrid optical amplifier system configured with multiple amplifying sections connected in a cascaded configuration. The method includes a sequence of operations for managing both local gain compression and system-level signal gain using a nested control architecture and an embodiment of this method is illustrated in FIG. 19.

Initially, at step 2001 a first portion of the optical signal spectrum is amplified using a first gain medium, such as an erbium-doped fiber amplifier (EDFA), in a first amplifying section. At step 2002 a second portion of the optical signal spectrum is simultaneously amplified (step 2002) using a second gain medium, such as a bismuth-doped fiber amplifier (BDFA) or bismuth-erbium co-doped fiber amplifier (BEDFA), in a second amplifying section. The two amplifying sections are connected in a cascaded configuration, with either the EDFA or BDFA/BEDFA positioned upstream depending on the spectral band arrangement (e.g., C+L or E+S).

To stabilize the gain compression level of the second gain medium, at step 2003 the method includes monitoring an ASE signal associated with the second gain medium. The ASE signal lies outside the main signal band and serves as an indicator of the gain compression state. Based on the monitored ASE power, at step 2004 an optical control parameter is adjusted to maintain the gain compression level of the second amplifying section at a predefined value.

In some embodiments, the ASE signal is extracted via a narrowband optical bandpass filter positioned at the output of the second gain medium. The filtered ASE signal is then directed to a photodetector, which generates a feedback signal used to control the second pump power supplied to the second gain medium. This feedback mechanism forms part of an ASE feedback control loop for dynamically adjusting the gain compression.

In some embodiments, the method instead employs OGC technique to regulate the gain compression level. In these configurations, narrowband optical filters centered at a defined ASE wavelength (e.g., around 14xx or 16xx nm) are positioned at both the input and output ports of the second amplifying section. The out-band ASE signal is extracted from the output port and routed through a VOA. The attenuated ASE signal is then recirculated into the second gain medium via the input-side narrowband optical filter. The attenuation level of the VOA acts as the optical control parameter and is adjusted to lock the circulating ASE power, thereby stabilizing the gain compression without requiring electrical feedback.

In parallel with the gain compression control loop, at step 2005 the method further includes measuring the input and output optical signal powers of the hybrid optical amplifier system. At step 2006, these measurements are used to calculate the actual signal gain across the system. At step 2007 a general gain control loop adjusts the first pump power supplied to the first gain medium based on the calculated gain to maintain a predefined average signal gain for the entire amplifier system.

The method, as described, enables independent control of gain compression and overall gain, minimizes gain profile distortion under variable signal loading, and ensures consistent performance across wideband hybrid amplifier configurations.

The present disclosure describes approaches for controlling gain compression within hybrid optical amplifiers. In a first approach, an ASE feedback control loop is used, where photo-detected out-band ASE signals are monitored to dynamically adjust the pump power of the gain medium. In a second approach, OGC loop is employed, which relies on narrowband optical filters and a VOA to regulate gain compression entirely through optical means, without the need for electrical feedback. In both approaches, the gain compression control mechanism is nested within a general gain control loop that monitors the system's input and output signal powers and adjusts the upstream pump powers to maintain a consistent average signal gain. The various embodiments illustrate that this nested AGC architecture can be adapted using either separate or shared control loops, allowing for gain compression control of individual or multiple amplifier sections depending on system configuration.

This versatile architecture enhances gain stability, reduces profile distortion under variable signal loading, and ensures consistent performance across dynamically reconfigurable optical networks. The disclosed designs can be scalable, adaptable, and applicable to a broad class of wideband optical amplifier systems used in advanced wavelength-division multiplexed (WDM) communications.

Various acronyms and abbreviations used herein are indicated in the Table below.

| | Acronym/ |
|---|---|
| | Abbreviation/ |
| Full Name | Initialism |
| Optical Amplifier | OA |
| Wavelength Division Multiplexing | WDM |
| Erbium-Doped Fiber Amplifier | EDFA |
| Thulium-Doped Fiber Amplifier | TDFA |
| Bismuth-Doped Fiber Amplifier | BDFA |
| Bismuth-Erbium-Co-Doped Fiber Amplifier | BEDFA |
| Erbium-Doped Fiber | EDF |
| Thulium-Doped Fiber | TDF |
| Bismuth-Doped Fiber | BDF |
| Bismuth-Erbium-Co-Doped Fiber | BEDF |
| Raman Fiber Amplifier | RFA |
| Automatic Gain Control | AGC |
| Amplified Spontaneous Emission | ASE |
| Photodetector | PD |
| Optical Gain Clamping | OGC |
| Dynamic Gain Equalizer | DGE |
| Variable Optical Attenuator | VOA |
| Optical Band-Pass Filter | OBPF |

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. An optical amplifier system comprising:
a first amplifying section including a first gain medium connected to a first pump source, the first amplifying section configured to amplify optical signals in a first wavelength band;
a second amplifying section including a second gain medium connected to a second pump source, the second amplifying section configured to amplify optical signals in a second wavelength band different from the first wavelength band;
an amplified spontaneous emission (ASE) feedback loop configured to monitor an out-band ASE signal extracted from the output of the second amplifying section and to adjust the second pump source based on the extracted ASE signal for maintaining a predefined gain compression level of the second amplifying section; and
a general gain control loop configured to monitor input and output optical signal powers of the system to calculate an actual gain of the system, and to adjust the first pump source based on the actual gain to maintain an average signal gain at a predefined value, the ASE feedback loop being nested within the general gain control loop to form a nested gain control architecture.

2. The optical amplifier system of claim 1, wherein the first gain medium and the second gain medium are doped into a same optical fiber.

3. The optical amplifier system of claim 1, wherein the first amplifying section and the second amplifying section are implemented as physically separate optical fiber segments.

4. The optical amplifier system of claim 1, further comprising a plurality of the first amplifying sections and a plurality of the second amplifying sections connected in a cascaded configuration, with each of the second amplifying sections forming an ASE feedback loop.

5. The optical amplifier system of claim 1, wherein the first gain medium amplifies primarily the first wavelength band and partly the second wavelength band, and the second gain medium amplifies primarily the second wavelength band and partly the first wavelength band.

6. The optical amplifier system of claim 1, wherein the ASE feedback loop comprises a narrow optical bandpass filter positioned for extracting an out-band ASE signal from the second amplifying section, a photodetector for detecting the ASE signal, and an ASE control circuit configured to adjust the second pump source based on the detected ASE signal, the general gain control loop comprises a general gain control circuit configured to adjust the first pump source based on the detected input and output optical signal powers of the system.

7. The optical amplifier system of claim 1, wherein the first gain medium comprises erbium-doped fiber amplifier (EDFA) configured to amplify optical signals in the C-band, and the second gain medium comprises bismuth-doped fiber amplifier (BDFA) configured to amplify optical signals in the L-band.

8. The optical amplifier system of claim 1, wherein the first gain medium comprises erbium-doped fiber amplifier (EDFA) configured to amplify optical signals in the C-band, and the second gain medium comprises bismuth-erbium co-doped fiber amplifier (BEDFA) configured to amplify optical signals in the L-band.

9. The optical amplifier system of claim 1, wherein the first gain medium comprises bismuth-doped fiber amplifier (BDFA) configured to amplify optical signals in the E-band and the shorter wavelength portion of the S-band, and the second gain medium comprises erbium-doped fiber amplifier (EDFA) configured to amplify signals in the longer wavelength portion of the S-band.

10. An optical amplifier system comprising:
a first amplifying section including a first gain medium connected to a pump source, the first amplifying section configured to amplify optical signals in a first wavelength band;
a second amplifying section including a second gain medium configured to amplify optical signals in a second wavelength band different from the first wavelength band;
an optical gain clamping (OGC) loop including a variable optical attenuator (VOA) optically coupled to the input and output of the second amplifying section, the OGC loop configured to extract an out-band amplified spontaneous emission (ASE) signal from the output and recirculate an attenuated ASE signal to the input of the second amplifying section to maintain a predefined gain compression level of the second amplifying section, and
a general gain control loop configured to monitor input and output optical signal powers of the system to calculate an actual gain of the system, and to adjust the pump source based on the actual gain to maintain an average signal gain at a predefined value, the OGC loop being nested within the general gain control loop to form a nested gain control architecture.

11. The optical amplifier system of claim 10, wherein the first gain medium and the second gain medium are doped into a same optical fiber.

12. The optical amplifier system of claim 10, wherein the first amplifying section and the second amplifying section are implemented as physically separate optical fiber segments.

13. The optical amplifier system of claim 10, wherein the first gain medium amplifies primarily the first wavelength band and partly the second wavelength band, and the second gain medium amplifies primarily the second wavelength band and partly the first wavelength band.

14. The optical amplifier system of claim 10, comprising a plurality of the first amplifying sections and a plurality of the second amplifying sections connected in a cascaded configuration, with each of the second amplifying sections forming an OGC loop.

15. The optical amplifier system of claim 10, wherein the first gain medium comprises erbium-doped fiber amplifier (EDFA) configured to amplify optical signals in the C-band, and the second gain medium comprises bismuth-doped fiber amplifier (BDFA) configured to amplify optical signals in the L-band.

16. The optical amplifier system of claim 10, wherein the first gain medium comprises erbium-doped fiber amplifier (EDFA) configured to amplify optical signals in the C-band, and the second gain medium comprises bismuth-erbium co-doped fiber amplifier (BEDFA) configured to amplify optical signals in the L-band.

17. The optical amplifier system of claim 10, wherein the first gain medium comprises bismuth-doped fiber amplifier (BDFA) configured to amplify optical signals in the E-band and the shorter wavelength portion of the S-band, and the second gain medium comprises erbium-doped fiber amplifier (EDFA) configured to amplify signals in the longer wavelength portion of the S-band.

18. A method for controlling gain in a hybrid optical amplifier system, comprising:
amplifying a first portion of an optical signal spectrum using a first gain medium in a first amplifying section of the system;
amplifying a second portion of the optical signal spectrum using a second gain medium in a second amplifying section of the system, the first amplifying section and the second amplifying section connected in a cascaded configuration;
maintaining a gain compression level of the second gain medium by monitoring an out-band amplified spontaneous emission (ASE) signal associated with the second gain medium and adjusting an optical control parameter based on the monitored ASE signal;
measuring input and output optical signals of the optical amplifier system;
calculating an actual signal gain based on the measured input and output signals; and
adjusting a first pump power sent to the first gain medium based on the calculated actual signal gain to maintain a predefined average signal gain of the optical amplifier system.

19. The method of claim 18, wherein the optical control parameter comprises a second pump power sent to the second gain medium, and the monitoring of the out-band ASE signal comprises detecting the ASE signal using a photodetector positioned after a narrow optical bandpass filter provided at an output of the second gain medium.

20. The method of claim 18, wherein the optical control parameter comprises an attenuation level of a variable optical attenuator (VOA) configured to recirculate an attenuated ASE signal to the second gain medium through an optical gain clamping (OGC) loop coupled to the input and output of the second gain medium.
